(19) United States
(12) Patent Application Publication
(10) Pub. No.: US 2023/0325853 A1
(43) Pub. Date: Oct. 12, 2023

(54) METHODS, SYSTEMS, ARTICLES OF MANUFACTURE, AND APPARATUS TO IMPROVE MODELING EFFICIENCY

(71) Applicant: Nielsen Consumer LLC, Chicago, IL (US)

(72) Inventors: Alvin Lim, Chicago, IL (US); Hao Chen, Chicago, IL (US); Lanshan Han, Chicago, IL (US); Dinesh Mehta, Chicago, IL (US)

(21) Appl. No.: 18/156,957

(22) Filed: Jan. 19, 2023

Related U.S. Application Data
(60) Provisional application No. 63/328,071, filed on Apr. 6, 2022.

(51) Int. Cl. G06Q 30/0201

(52) U.S. Cl. CPC G06Q 30/0201

(57) ABSTRACT

Methods, apparatus, systems, and articles of manufacture are disclosed to improve modeling efficiency identify a first quantity of modes corresponding to a task, apply a model to the first quantity of modes to determine a first contributory effect corresponding to the task, select a first portion of the first quantity of modes to exclude to generate a second quantity of modes corresponding to the task, apply the model to the second quantity of modes to determine a second contributory effect corresponding to the task, and cause a trigger response based on a difference value between the first contributory effect and the second contributory effect.

### RELATED APPLICATION

This patent claims the benefit of U.S. Provisional Patent Application No. 63/328,071, which was filed on Apr. 6, 2022. U.S. Provisional Patent Application No. 63/328,071 is hereby incorporated herein by reference in its entirety. Priority to U.S. Provisional Patent Application No. 63/328,071 is hereby claimed.

### FIELD OF THE DISCLOSURE

This disclosure relates generally to marketing activities and, more particularly, to methods, systems, articles of manufacture, and apparatus to improve modeling efficiency.

### BACKGROUND

In recent years, marketing activities, such as television advertisement, discounting, direct mail, etc., are prevailing approaches for market participants (e.g., consumer packaged goods manufacturers, service providers, market analysts, etc.) to enhance their brand awareness and product/service messaging to consumers to increase sales. Because marketing activities require financial and/or effort investments, the market participants have an interest to measure the rate of return (ROR) on those marketing activities.

### BRIEF DESCRIPTION OF THE DRAWINGS

FIG. 1 is a schematic illustration of an example environment to improve modeling efficiency.

FIG. 2A is a block diagram of example rate of return circuitry to facilitate the example environment of FIG. 1.

FIG. 2B is an illustration of example contributory effect to facilitate the example environment of FIG. 1.

FIGS. 3-5 are flowcharts representative of example machine readable instructions and/or example operations that may be executed by example processor circuitry to implement the example rate of return circuitry of FIGS. 1 and 2A.

FIG. 6 is a block diagram of an example processing platform including processor circuitry structured to execute the example machine readable instructions and/or the example operations of FIGS. 3-5 to implement the example rate of return circuitry of FIGS. 1 and 2A.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

To measure the rate of return (ROR) on marketing activities (advertising, price reduction, etc.), practitioners usually collect sales data, marketing data, as well as other related data, at a periodic (e.g., weekly) level, and then conduct statistical analysis to relate sales metrics (e.g., quantity) to one or more marketing activities as well as other non-marketing factors (e.g., price, holidays, seasonality, etc.). While examples disclosed herein refer to a rate of return for example purposes, concepts herein are not limited to that. The ROR is described herein to aid in understanding the inventive concepts, and any other type of response variable may be used (e.g., a sales volume) with a goal of measuring marketing campaign effectiveness. Statistical models are constructed for this purpose. Such statistical models are challenging to estimate. In practice, the estimation is often accomplished in multiple phases. For example, the practitioners often first independently estimate certain parameters (e.g., shape, scale, etc.) involved in nonlinear transformations and then estimate the corresponding coefficients, followed by an adjustment process to ensure that the coefficients satisfy one or more constraints (e.g., verifying coefficient values are within threshold expectations). This process is independently repeated for each mode. As used herein, a “mode” is a modeling parameter of interest, such as an independent variable that is capable of being controlled. Examples disclosed herein include modes related to marketing activity campaigns, such as (but not limited to) television (e.g., television advertising campaigns), radio (e.g., radio advertising campaigns), newspaper (e.g., newspaper and/or other print-based advertising campaigns), etc. Generally speaking, a type of marketing activity campaign includes a particular cost to implement and/or otherwise administer. Marketing activity campaigns are used for categories. As used herein, a “category” is a group of common products. Examples of categories related to groups of products include dairy (milk, yogurt, butter, etc.), produce (apples, bananas, etc.), etc. Furthermore, the type of marketing activity campaign includes a particular efficacy. For instance, some regions of interest (e.g., a particular neighborhood, a particular city, etc.) have particular responses to a marketing activity campaign for a category.

This multi-phase and otherwise isolated process represents separate phases and silos, which is not only complicated and computationally expensive to implement and automate, but also leads to inaccurate estimation of the coefficients. Such inaccurate estimation results in erroneous measurements of the effects corresponding to marketing activities (e.g., sales). Unlike traditional modeling techniques, which represent ad hoc processes that consider modes in isolation, examples disclosed herein streamline the modeling process to estimate all modes of interest in a codependent manner. In other words, examples disclosed herein appreciate circumstances in which some modes of interest have some effect on other modes of interest. Thus, when such different modes are evaluated independently of each other, particular effects cannot be appreciated and/or otherwise detected. Additionally, when traditional siloed techniques are applied, computationally expensive post-processing tasks are necessary to combine the independently analyzed modes.

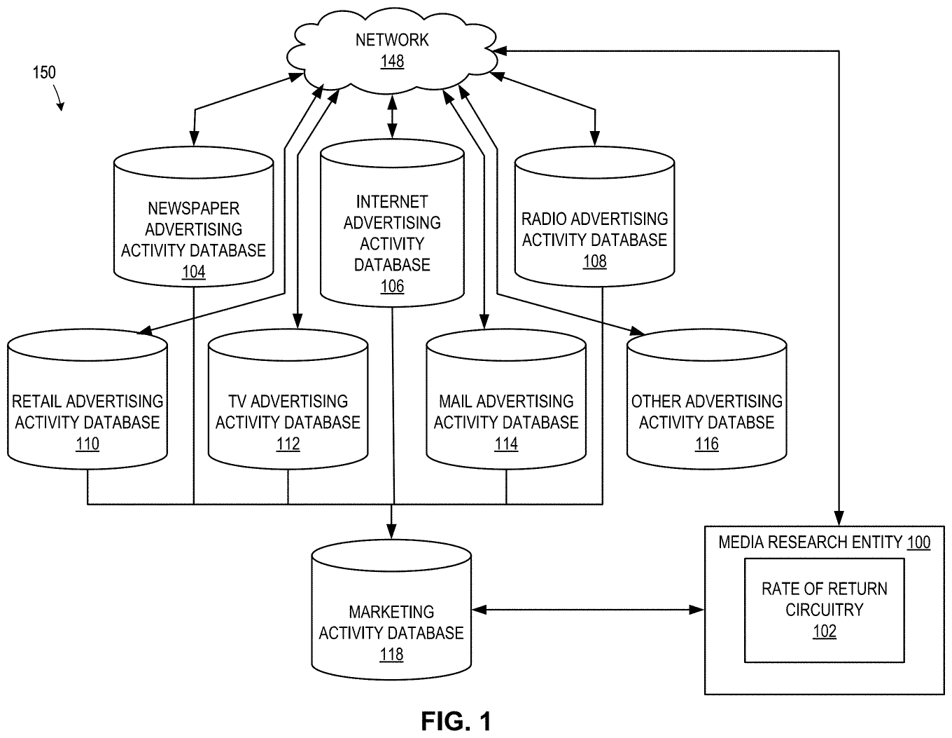

FIG. 1 is a schematic illustration of an example environment 150 to improve modeling efficiency. In the illustrated example of FIG. 1, the environment 150 includes an example media research entity (MRE) 100 communicatively connected to any number of different data sources. For instance, the example MRE of FIG. 1 is communicatively connected to an example network 148 that is further communicatively connected to an example newspaper advertising activity database 104, an example internet advertising activity database 106, an example radio advertising activity database 108, an example retail advertising activity database 110, an example television advertising activity database 112, an example mail advertising activity database 114, and an example other advertising activity database 116. While the illustrated example of FIG. 1 includes the aforementioned databases (e.g., data sources), examples disclosed herein are not limited thereto. In some examples, the aforementioned databases and/or data from such databases is aggregated into an example marketing activity database 118 that is either communicatively connected to the MRE 100 via the example network 148, and/or directly communicatively connected to the MRE 100. As described in further detail below, the MRE 100 includes example rate of return circuitry 102 to improve modeling efficiency as explained with a use case scenario of determining a rate of return on marketing activity data. While examples disclosed herein consider a use case scenario of determining a rate of return for implementing different types of marketing strategies, such examples disclosed herein are not limited to that use case scenario.

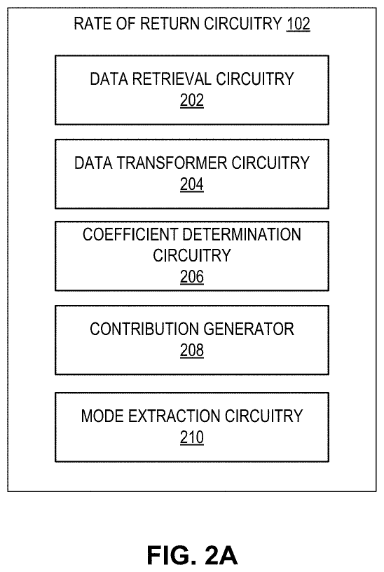

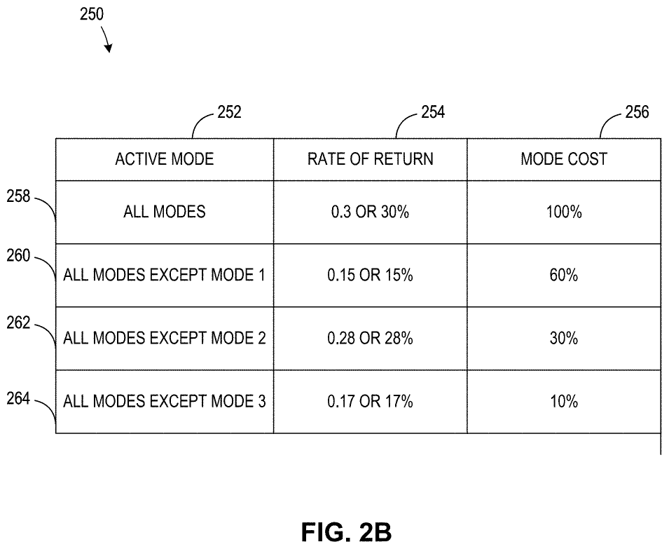

FIG. 2A illustrates additional detail corresponding to the example rate of return circuitry 102 of FIG. 1. In the illustrated example of FIG. 2A, the example rate of return circuitry 102 includes example data retrieval circuitry 202, example data transformer circuitry 204, example coefficient determination circuitry 206, example contribution generator circuitry 208, and example mode extraction circuitry 210. In operation, and as described in further detail below, the example data retrieval circuitry 202 retrieves, receives and/or otherwise obtains input marketing activity data, the example data transformer circuitry 204 transforms the input marketing activity data to account for a rate at which responses from marketing activities decay and marketing activities saturate, the example coefficient determination circuitry 206 determines one or more coefficients from the decay rate and saturation factor applied marketing activity data and restricts the coefficient, the example contribution generator circuitry 208 determines sales contributions for all modes based on the restricted coefficient, and the example mode extraction circuitry 210 extracts mode information to generate rate of return data based on the sales contributions.

As described above, FIG. 2A is a block diagram of the example rate of return circuitry 102 to improve modeling efficiency (as described in an example use case of determining a rate of return). The example rate of return circuitry 102 of FIGS. 1 and 2A may be instantiated (e.g., creating an instance of, bring into being for any length of time, materialize, implement, etc.) by processor circuitry such as a central processing unit executing instructions. Additionally or alternatively, the example rate of return circuitry 102 of FIGS. 1 and 2A may be instantiated (e.g., creating an instance of, bring into being for any length of time, materialize, implement, etc.) by an ASIC or an FPGA structured to perform operations corresponding to the instructions. It should be understood that some or all of the circuitry of FIGS. 1 and 2A may, thus, be instantiated at the same or different times. Some or all of the circuitry may be instantiated, for example, in one or more threads executing concurrently on hardware and/or in series on hardware. Moreover, in some examples, some or all of the circuitry of FIGS. 1 and 2A may be implemented by microprocessor circuitry executing instructions to implement one or more virtual machines and/or containers.

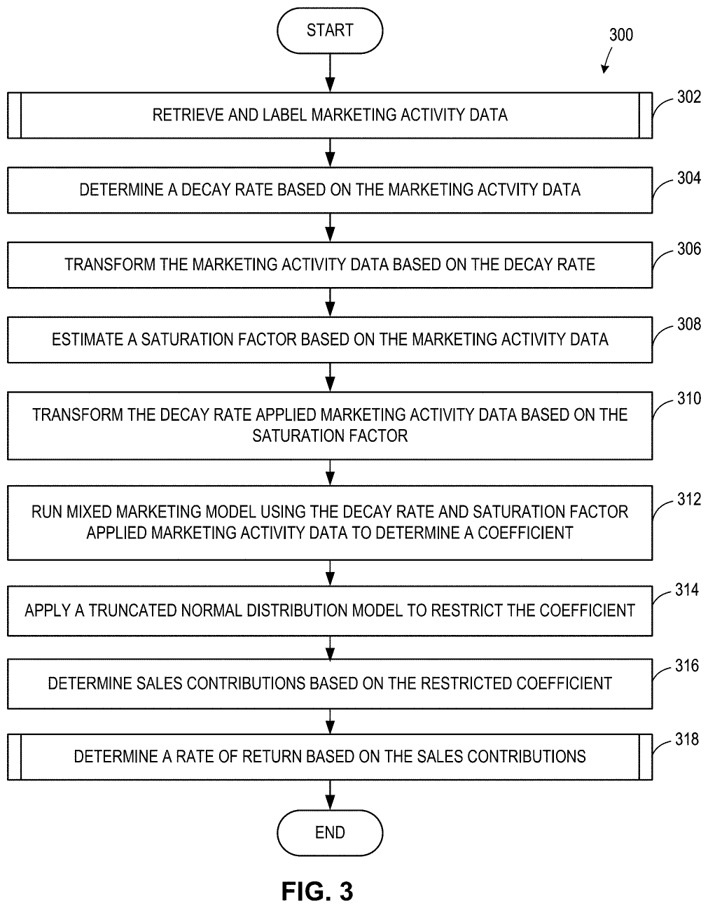

In some examples, the data retrieval circuitry 202 is instantiated by processor circuitry executing data retrieval instructions and/or configured to perform operations such as those represented by the flowcharts of FIGS. 3 through 5. In some examples, the data transformer circuitry 204 is instantiated by processor circuitry executing data transformer instructions and/or configured to perform operations such as those represented by the flowcharts of FIGS. 3 through 5. In some examples, the coefficient determination circuitry 206 is instantiated by processor circuitry executing coefficient determination instructions and/or configured to perform operations such as those represented by the flowcharts of FIGS. 3 through 5. In some examples, the contribution generator circuitry 208 is instantiated by processor circuitry executing contribution generator instructions and/or configured to perform operations such as those represented by the flowcharts of FIGS. 3 through 5. In some examples, the mode extraction circuitry 210 is instantiated by processor circuitry executing mode extraction instructions and/or configured to perform operations such as those represented by the flowcharts of FIGS. 3 through 5.

Returning to the illustrated example of FIG. 2A, in operation the data retrieval circuitry 202 retrieves, receives and/or otherwise obtains input marketing data from the marketing activity database 118 and/or one or more of the databases illustrated in FIG. 1. The example data retrieval circuitry 202 parses the marketing activity data to identify a mode. As used herein, a “mode” is a modeling parameter of interest, such as an independent variable that is capable of being controlled. Examples disclosed herein include modes related to marketing activity campaigns, such as (but not limited to) television (e.g., television advertising campaigns), radio (e.g., radio advertising campaigns), newspaper (e.g., newspaper and/or other print-based advertising campaigns), etc. Generally speaking, a type of marketing activity campaign includes a particular cost to implement and/or otherwise administer. Furthermore, the type of marketing activity campaign includes a particular efficacy. For instance, some regions of interest (e.g., a particular neighborhood, a particular city, etc.) have particular responses to a marketing activity campaign. As such, metrics that consider both a marketing activity cost and efficacy will allow cost judicious selection of particular marketing activity campaigns for one or more regions of interest. However, while examples disclosed herein use marketing activities to illustrate the inventive subject matter, such use cases are for illustration and not limitation.

As described above, marketing activity data is a function of each mode that is active for a particular advertising strategy implemented by an organization (e.g., a retailer, a product manufacturer, etc.) and/or market analyst. If the example data retrieval circuitry 202 determines that there is a mode to be analyzed for its performance during a campaign, the marketing activity data corresponding to that particular mode is labeled and stored for later evaluation by the example data retrieval circuitry 202. If the example data retrieval circuitry 202 determines that there are one or more additional modes that should also be analyzed for their corresponding performance/capabilities during the campaign, the marketing activity data corresponding to the mode is labeled and stored for later evaluation by the example data retrieval circuitry 202. As explained above, the use case disclosed herein can apply to marketing environment(s), but also examples disclosed herein can apply to any environment and/or use case scenario.

Responses (e.g., dependent variables, such as effects of an applied independent variable or stimulus, such as an applied category mode) from marketing activities will decay from the point (e.g., time) when they are introduced into the market. Additionally, in some examples while responses from marketing activities initially cause an effect having a first magnitude (e.g., a relatively high rate of sales), such activities diminish over time and/or otherwise slow down as the stimulus marketing activities saturate, maintain and/or continue to increase. Generally speaking, the initial introduction of such a stimulus causes a reaction and generates a new awareness in a candidate purchasing audience. However, as time goes on the stimulus may have reached the desired audience to a point where continued exposure to the stimulus no longer motivates the target candidate audience to purchase more product(s). To account for a rate at which responses from marketing activities decay over time and marketing activities saturate, the example data transformer circuitry 204 transforms the input marketing activity data in two phases. A first example phase to transform the input marketing activity data includes the example data transformer circuitry 204 determining a decay rate based on the input marketing activity data. In some examples, the example data transformer circuitry 204 determines the decay rate of the input marketing activity data in a manner consistent with example Equation 1.

$$c ( {x}_{1} , … , {x}_{t} ; α ) = {\sum }_{τ = 0}^{l - 1} {α}^{τ} {x}_{t - τ} , ∀ t = l , … , w ; \qquad Equation 1.$$

In the illustrated example of Equation 1, c represents a function of x₁, . . . xₜ, t represents a current week number, xₜ represents targeted rating points (e.g., level of activity) of an advertisement in a week t, l represents a number of weeks when the response from the marketing activities becomes negligible (e.g., when a threshold value, representing little or no response from the marketing activities is satisfied), a represents a constant decay rate (e.g., unknown parameters), w represents a max week number, and τ represents an iterator. The decay rate, α, is determined by the example data transformer circuitry 204. In some examples, decay rate of the input marketing activity data is determined by estimation based on a user's (e.g., a market analyst prior observation of a particular stimulus) prior experience. The example data transformer circuitry 204 applies the decay rate to the input marketing activity data for the first transformation phase.

A second example phase to transform the input marketing activity data includes the example data transformer circuitry 204 estimating a saturation factor based on the input marketing activity data by applying a cumulative distribution function of Weibull distribution and then estimating the saturation factor therefrom. The Weibull distribution captures either a C-shape or S-shape response function by the example data transformer circuitry 204. Due to a saturation effect of marketing activities, the response function is typically a C-shape (concave increasing) or S-shape (non-concave increasing). The cumulative distribution function of Weibull distribution is applied by the example data transformer circuitry 204 to estimate the saturation factor in marketing activities due to the cumulative distribution function of Weibull distribution's having flexibility in representing both the C-shape (when 0<k≤1) and the S-shape (when k>1) curves, where k represents a scale parameter. Both the C-shape or S-shape curves generated by the example data transformer circuitry 204 represents the saturation factor effectively by an indication of a plateauing effect towards an end of the curve trajectory. In some examples, the example data transformer circuitry 204 estimates the saturation factor in a manner consistent with example Equation 2.

$$s ( \tilde{x} ; λ , k ) = 1 - exp ( - {( \frac{\tilde{x}}{λ} )}^{k} ) \qquad Equation 2.$$

In the illustrated example of Equation 2, s represents a function of \tilde{x}; λ, k, \tilde{x} represents targeted rating points (e.g., level of activity) of an advertisement, λ represents a shape parameter, and k represents a scale parameter. The saturation factor is determined by the example data transformer circuitry 204 estimating the saturation factor. The example data transformer circuitry 204 applies the saturation factor to the decay rate applied marketing activity data for the second transformation phase.

After transformations to the input marketing activity data, a coefficient is determined by the example coefficient determination circuitry 206. The coefficient is a measurement of degrees of closeness with the ROR for all modes or a first quantity of modes. The first quantity of modes represents all modes that may have been applied for a particular campaign, for instance. As illustrated in further detail below, the coefficient is compared to the rate of return for marketing activity by the example mode extraction circuitry 210 to provide a measurement of degrees of closeness with the ROR. For instance, the larger the coefficient is, the higher the ROR is as the marketing activity increases. In some examples, more than one coefficient may be determined by the example coefficient determination circuitry 206. In some examples, all coefficients together may be used to determine model accuracy in terms of how close the model can predict actual ROR. The example coefficient determination circuitry 206 executes the mixed marketing model using the decay rate and saturation factor applied marketing activity data to determine a coefficient. The example coefficient determination circuitry 206 applies a truncated normal distribution model to restrict the coefficient. The example coefficient determination circuitry 206 restricts the coefficient to a lower and upper bound through the truncated normal distribution model. The restriction of the coefficient represents common rules that must be satisfied for marketing participants. For example, restricting the coefficient may allow for a decay rate to be within a lower bound of 0 and an upper bound of 1 for marketing activities to decrease, instead of increasing, as time goes on. Another example of restricting the coefficient is to fix a lower bound and an upper bound for a saturation factor to regulate marketing activity to not increase a ROR indefinitely (e.g., a ROR will not increase even if a marketing participant continues to invest in a marketing activity. The gain of restricting the coefficient outweighs the cost of applying the restriction to the coefficient. The output of applying the truncated normal distribution model by the example coefficient determination circuitry 206 is the restricted coefficient which is used to determine sales contributions for all modes by the example contribution generator circuitry 208.

The example contribution generator circuitry 208 generates sales contributions for all modes. For example, if a category uses modes of advertising such as TV advertising campaigns, Internet advertising campaigns, and radio advertising campaigns, then the sales contributions inclusive of all three of these modes would be generated by the contribution generator circuitry 208. The sales contributions are utilized to determine rate of return data corresponding to the modes, as explained below.

At a high-level, a task is an objective of utilizing a model. Examples disclosed herein refer to a task as the rate of return on marketing activity data. The rate of return represents a contributory effect of a mode or multiple modes. The rate of return generated by the example mode extraction circuitry 210 is a value between 0 and 1. In some examples, the rate of return may be represented by a percentage. The contributory effect generated by the example mode extraction circuitry 210 represents a performance metric. As shown in FIG. 2B, examples of a performance metric are a sales boost or a contributory cost of implementing a mode. FIG. 2B is illustrated in more detail below.

FIG. 2B is a table 250 of example contributory effects. In the illustrated example of FIG. 2B, the table 250 includes an example active mode column 252, an example rate of return column 254, and an example mode cost column 256. The example active mode column 252 of FIG. 2B indicates which one of any number of modes of interest is active during a model evaluation. The example rate of return column 254 of FIG. 2B indicates an efficacy metric corresponding to the active mode during the model evaluation (as measured from a baseline value of the model when there are no active modes types of interest during the model execution). The example mode cost column 256 of FIG. 2B indicates a cost associated with implementing the mode type corresponding to the example active mode column 252.

For example, an example first row 258 of FIG. 2B illustrates a model evaluation occurrence in which all modes of interest are applied as independent variables during the model evaluation. Compared to a baseline sales value (e.g., for a particular category of interest, a particular brand of interest, etc.), using and/or otherwise applying all modes of interest (e.g., implementing newspaper, radio and internet advertisements) results in an observed 30% boost in sales. Additionally, in the example first row 258 of FIG. 2B, using and/or otherwise applying all modes of interest includes an associated cost to the market analyst and/or organization that is implementing the marketing campaign. In the illustrated example of FIG. 2B, all modes of interest represent all of the advertising budget spend (e.g., the combination of newspaper, radio and Internet advertising), and is shown as 100%. The mode cost is 100% because all of the modes are taken into account. However, in some examples the data corresponding to the example mode cost column 256 may be represented as a currency (e.g., U.S. dollar) amount.

In the illustrated example of FIG. 2B, a second row 260 illustrates an instance of model evaluation (e.g., model execution) when a first mode type is excluded as a stimulus (e.g., independent variable). For example, if a first mode type is associated with Internet advertising, and is excluded from consideration during model evaluation, then the example rate of return column 254 indicates a value of 15%. At least one conclusion that the scenario of the second row 260 illustrates is that Internet advertising is a rather significant contribution to the overall rate of return for a marketing campaign (e.g., at least half of the benefit for the campaign was not realized by omitting the Internet advertising). In other words, there is a 15% change in rate of return compared to the rate of return for all modes. Additionally, the example mode cost column 256 illustrates that the first mode represents 60% of the overall campaign cost.

In the illustrated example of FIG. 2B, a third row 262 illustrates an instance of model evaluation (e.g., model execution) when a second mode type is excluded as a stimulus (e.g., independent variable). For example, if a second mode type is associated with radio advertising, and is excluded from consideration during model evaluation while all other modes are active during this model evaluation, then the example rate of return column 254 indicates a value of 28%. At least one conclusion that the scenario of the third row 262 illustrates is that radio advertising is a rather insignificant contribution to the overall rate of return for a marketing campaign (e.g., less than a tenth of the benefit for the campaign was not realized by omitting the radio advertising). In other words, the second modes is contributing to only a 2% sales boost or rate of return to the overall rate of return for a marketing campaign. Additionally, the example mode cost column 256 illustrates that the second mode represents 30% of the overall campaign cost.

In the illustrated example of FIG. 2B, a fourth row 264 illustrates an instance of model evaluation (e.g., model execution) when a third mode type is excluded as a stimulus (e.g., independent variable). For example, if a third modes type is associated with television advertising, and is excluded from consideration during model evaluation while all other modes are active, then the example rate of return column 254 indicates a value of 17%. At least one conclusion that the scenario of the fourth row 264 illustrates is that television advertising is a rather significant contribution to the overall rate of return for a marketing campaign (e.g., a little less than half of the benefit for the campaign was not realized by omitting the television advertising). In other words, the third mode is contributing to a 13% sales boost or rate of return to the overall rate of return for a marketing campaign. Additionally, the example mode cost column 256 illustrates that the third mode represents 10% of the overall campaign cost. In other words, the cost of using the third mode in marketing is the least expensive compared to the cost of using the first mode, 60%, or the second mode, 30%, in marketing.

Another way to compare the contributory effects is by using an index value. An index value represents a relationship between cost and effectiveness of a mode. In other words, the higher the index value, the more cost effective the mode. It is generated by comparing 1) change in rate of return of a mode from the rate of return of all modes, with 2) the mode cost. In this example, the index value for the first mode is 0.25. It is calculated by determining the difference between the rate of return of the first mode, 15% (as shown in the third row 260 and the second column 254), and the rate of return of all modes, 30% (as shown in the second row 258 and the second column 254). The difference of 15% is divided by the first mode cost, 60% (as shown in the second row 258 and third column 256). Using the same approach with values corresponding to the second mode and the third mode, the index value for the second mode is 0.06 and the index value for the third mode is 0.25, respectively. The third mode is the most cost effective as the index value is the highest among the modes. In totality, the example shows that the third mode or using television advertising is very helpful in terms of boosting sales and is the least costly compared to the other two modes shown in the example in FIG. 2B.

From the example shown in FIG. 2B, a response to act on the contributory effects triggered when a contributory effect surpasses a threshold value determined by, for example, a market participant. From the example shown in FIG. 2B, a market participant may decide to focus on using more television advertising as its prime marketing activity since it is least expensive and relatively helpful for sales. In some examples, if the contributory effects for modes of interest are the same, then a response may not be triggered to change a marketing activity course.

Returning to FIG. 2A, after a restricted coefficient representative of all mode or the first quantity of modes is determined by the example coefficient determination circuitry 206, the example mode extraction circuitry 210 determines a rate of return. For instance, the example mode extraction circuitry 210 determines the rate of return based on marketing activity data associated with all modes (e.g., all of the participating types of marketing vehicle, such as newspaper advertisements, Internet advertisements, radio advertisements, etc.). The rate of return inclusive of marketing activity data corresponding to the first quantity of modes (e.g., corresponding to the task of obtaining a rate of return) is determined by the example mode extraction circuitry 210 inputting the sales contributions into a mixed marketing model. The rate of return for the first quantity of modes represents a first contributory effect corresponding to the task of obtaining a rate of return. Further details about the rate of return are illustrated below.

As mentioned previously, the coefficient generated by the example coefficient determination circuitry 206 is a measurement of degrees of closeness with the ROR for all modes or a first quantity of modes. The restricted coefficient determined from the example coefficient determination circuitry 206 is compared to the rate of return for marketing activity data or task corresponding to all modes or the first quantity of modes determined by the mode extraction circuitry 210. The restricted coefficient is compared to the rate of return for marketing activity data by inputting a zero value in the mixed marketing model by the example mode extraction circuitry 210. The input of the zero value represents a rate of return on marketing activity data associated with all modes. In other words, a zero value is inputted into the mixed marking model when the desired rate of return is for all modes. The restricted coefficient value and the rate of return value for all modes should be identical or close to identical. The restricted coefficient value and rate of return value for all modes should be identical or close to identical because it represents how the marketing activity data, which was transformed by the two-phase process by the data transformer circuitry 204, does not need to be further adjusted. The closeness of the restricted coefficient value and the rate of return value represents how accurate the transformations of the marketing activity data were and how no additional adjustment to the marketing activity data is needed. In some examples, the restricted coefficient may change over the course of running the mixed marketing model, representing a more accurate value over time, by the example rate of return circuitry 102.

In some examples, a first portion of the first quantity of modes is excluded by the example mode extraction circuitry 210 to generate a second quantity of modes or a mode of interest with a second contributory effect. The second contributory effect (e.g., response) of a different mode of interest provides information such a sales boost or contributory cost in view of the alternate circumstances corresponding to a different mode type. For instance, a first mode or first quantity of modes may be associated with the application of newspaper advertisements plus television advertisements plus on-line (Internet) advertisements. This particular first quantity of modes is a stimulus to cause a corresponding type of effect (e.g., a particular boost in sales for a product of interest that is associated with a marketing campaign. On the other hand, a second quantity of modes (e.g., different than the first quantity of modes) may be considered in which one of the individual mode types is removed. As such, the corresponding effect will likely exhibit a different outcome, such as sales metrics that are lower than what was observed in connection with the first modes of interest. This difference provides valuable insight for market analysts when designing marketing campaigns in a manner that is more efficient, effective and/or otherwise cost effective.

Returning to how the rate of return is generated by the example mode extraction circuitry 210, if there is a mode of interest available, it is selected by the mode extraction circuitry 210. The mode of interest is extracted or subtracted from the mixed marketing model by the mode extraction circuitry 210. The mode extraction circuitry 210 re-runs or re-applies the mixed marketing model based on the combination of remaining modes (e.g., the remaining independent variables in view of the recently removed independent variable) to obtain an updated rate of return or second contributory effect representing all modes minus the mode of interest. The updated rate of return is stored by the mode extraction circuitry 210. If there are additional modes of interest that have not been previously excluded, the example mode extraction circuitry 210 determines if the previously extracted mode of interest is to be added back into the mixed marketing model prior to selecting an additional mode of interest. If so, the example mode extraction circuitry 210 inputs the previously extracted mode of interest into the mixed marketing model. If not, the next mode of interest is selected by the mode extraction circuitry 210. The next mode of interest is extracted or subtracted from the mixed marketing model by the mode extraction circuitry 210. The mode extraction circuitry 210 re-runs the mixed marketing model based on the combination of remaining odes (e.g., the remaining independent variables in view of the recently removed independent variable) to obtain an updated rate of return for all modes minus the next mode of interest and previously extracted modes of interest. As illustrated in FIG. 2B, the contributory effects are used to trigger a response or a desired outcome from results of the mixed marketing model.

In some examples, the data retrieval circuitry 202 apparatus includes means for retrieving input marketing activity data, the data transformer circuitry 204 includes means for transforming the input marketing activity data, the coefficient determination circuitry 206 includes means for determining a coefficient from decay rate and saturation factor applied marketing activity data and restricting the coefficient, the contribution generator circuitry 208 includes means for determining sales contributions based on the restricted coefficient, and the mode extraction circuitry 210 includes means for extracting a mode to generate a rate of return.

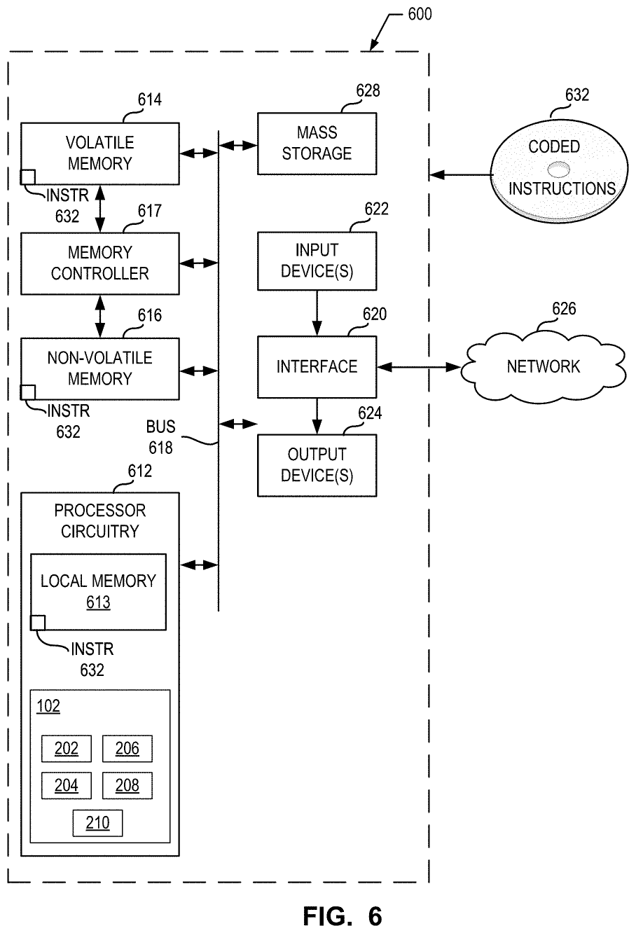

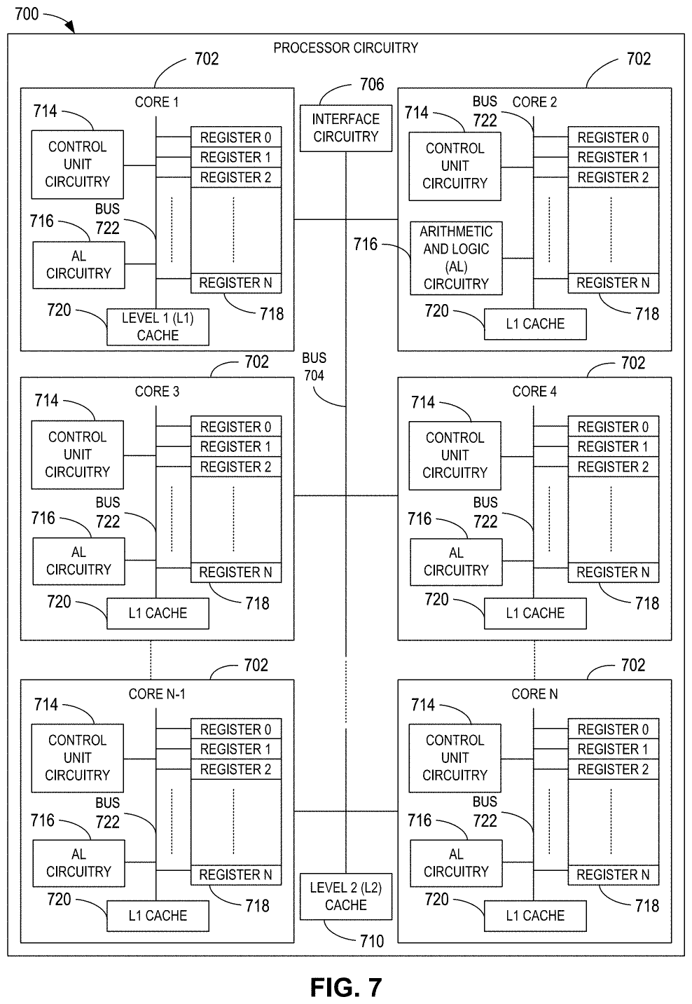

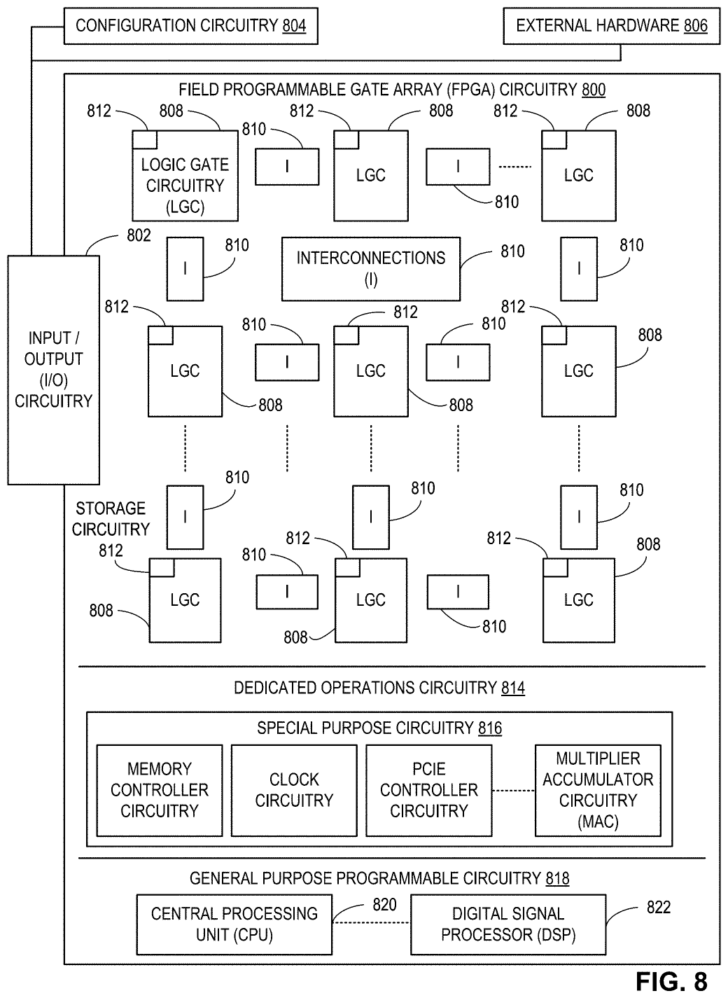

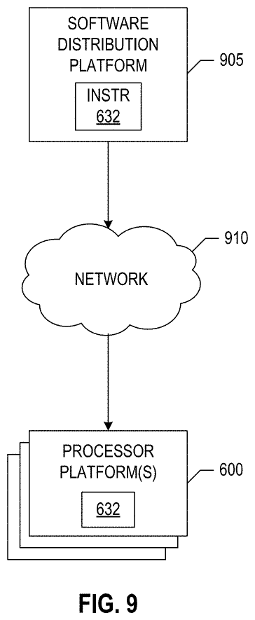

For example, the means for retrieving input marketing activity data, transforming the input marketing activity data, determining a coefficient from decay rate and saturation factor applied marketing activity data and restricting the coefficient, and extracting a mode to generate a rate of return may be implemented by example data retrieval circuitry 202, example data transformer circuitry 204, example coefficient determination circuitry 206, example contribution generator circuitry 208, and example mode extraction circuitry 210, respectively. In some examples, the aforementioned circuitry may be instantiated by processor circuitry such as the example processor circuitry 612 of FIG. 6. For instance, the aforementioned circuitry may be instantiated by the example microprocessor 700 of FIG. 7 executing machine executable instructions such as those implemented by at least blocks 902, 904 of FIG. 9. In some examples, the aforementioned circuitry may be instantiated by hardware logic circuitry, which may be implemented by an ASIC, XPU, or the FPGA circuitry 800 of FIG. 8 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example rate of return circuitry 102 of FIG. 2A is illustrated in FIG. 2A, one or more of the elements, processes, and/or devices illustrated in FIG. 2A may be combined, divided, re-arranged, omitted, eliminated, and/or implemented in any other way. Further, the example data retrieval circuitry 202, example data transformer circuitry 204, example coefficient determination circuitry 206, example contribution generator circuitry 208, example mode extraction circuitry 210, and/or, more generally, the example rate of return circuitry 102 of FIG. 2A, may be implemented by hardware alone or by hardware in combination with software and/or firmware. Thus, for example, any of the example data retrieval circuitry 202, example data transformer circuitry 204, example coefficient determination circuitry 206, example contribution generator circuitry 208, example mode extraction circuitry 210, and/or, more generally, the example rate of return circuitry 102 of FIG. 2A, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example rate of return circuitry 102 of FIG. 2A may include one or more elements, processes, and/or devices in addition to, or instead of, those illustrated in FIG. 2A, and/or may include more than one of any or all of the illustrated elements, processes and devices.

A flowchart representative of example machine readable instructions, which may be executed to configure processor circuitry to implement the example rate of return circuitry 102 of FIG. 2A, is shown in FIGS. 3-5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3-5, many other methods of implementing the example rate of return circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3-5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or phases, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or phases, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

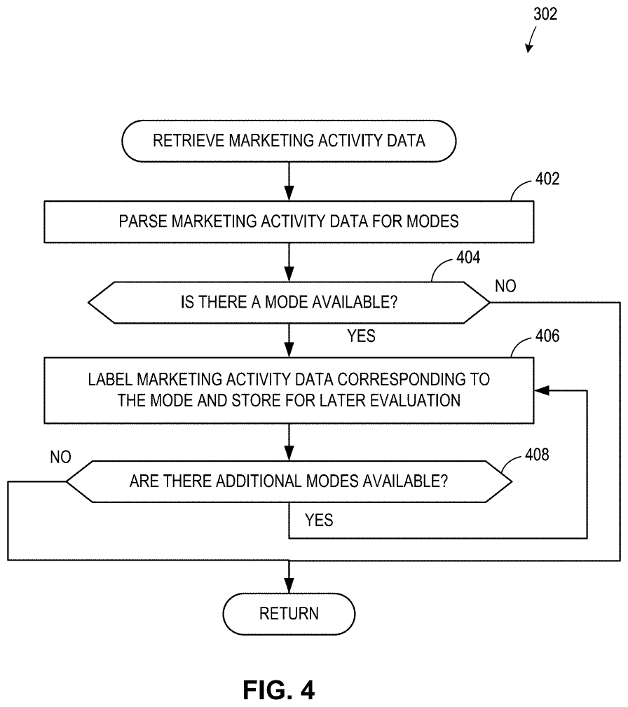

FIG. 3 is a flowchart representative of example machine readable instructions and/or example operations 300 that may be executed and/or instantiated by processor circuitry to improve modeling efficiency. The machine readable instructions and/or the operations 300 of FIG. 3 begin at block 302, at which the example data retrieval circuitry 202 retrieves, receives and/or otherwise obtains input marketing activity data. At block 302, the example data retrieval circuitry 202 obtains input marketing data from the marketing activity database 118 and/or one or more of the databases illustrated in FIG. 1. As described in further detail below, FIG. 4 illustrates an example subroutine 302 of the example machine readable instructions and/or the operations 300 of FIG. 3.

At block 304, the example data transformer circuitry 204 determines a rate at which responses from marketing activities decay. In some examples, the example data transformer circuitry 204 determines the decay rate of the input marketing activity data in a manner consistent with example Equation 1 (block 304). In some examples, the decay rate of the input marketing activity data is be determined by estimation based on a user's prior experience (block 304).

At block 306, the example data transformer circuitry 204 applies the decay rate, determined by the example data transformer circuitry 204, to the input marketing activity data to transform the input marketing activity data.

At block 308, the example data transformer circuitry 204 determines and/or otherwise estimates a factor or metric at which marketing activities saturate. In some examples, the example data transformer circuitry 204 estimates the saturation factor in a manner consistent with example Equation 2 (block 308).

At block 310, the example data transformer circuitry 204 applies the saturation factor, determined by the example data transformer circuitry 204, to the decay rate applied marketing activity data to transform the decay rate applied marketing activity data.

At block 312, the example coefficient determination circuitry 206 runs a mixed marketing model using the decay rate and saturation factor applied marketing activity data to determine a coefficient. In particular, the application of the mixed marketing model to the decay rate and saturation factor enables and/or otherwise facilitates the ability for one or more coefficients to be determined.

At block 314, the example coefficient determination circuitry 206, constrains the coefficient. The example coefficient determination circuitry 206 restricts the coefficient by applying a truncated normal distribution model (block 314). For example restricting the coefficient may allow for a decay rate to be within a lower bound of 0 and an upper bound of 1 for marketing activities to decrease, instead of increasing, as time goes on. Another example of restricting the coefficient is to fix a lower bound and an upper bound for a saturation factor to regulate marketing activity to not increase a ROR indefinitely (e.g., a ROR will not increase even if a marketing participant continues to invest in a marketing activity. The gain of restricting the coefficient outweighs the cost of applying the restriction to the coefficient. The output of applying the truncated normal distribution model to the coefficient by the example coefficient determination circuitry 206 is the restricted coefficient (block 314).

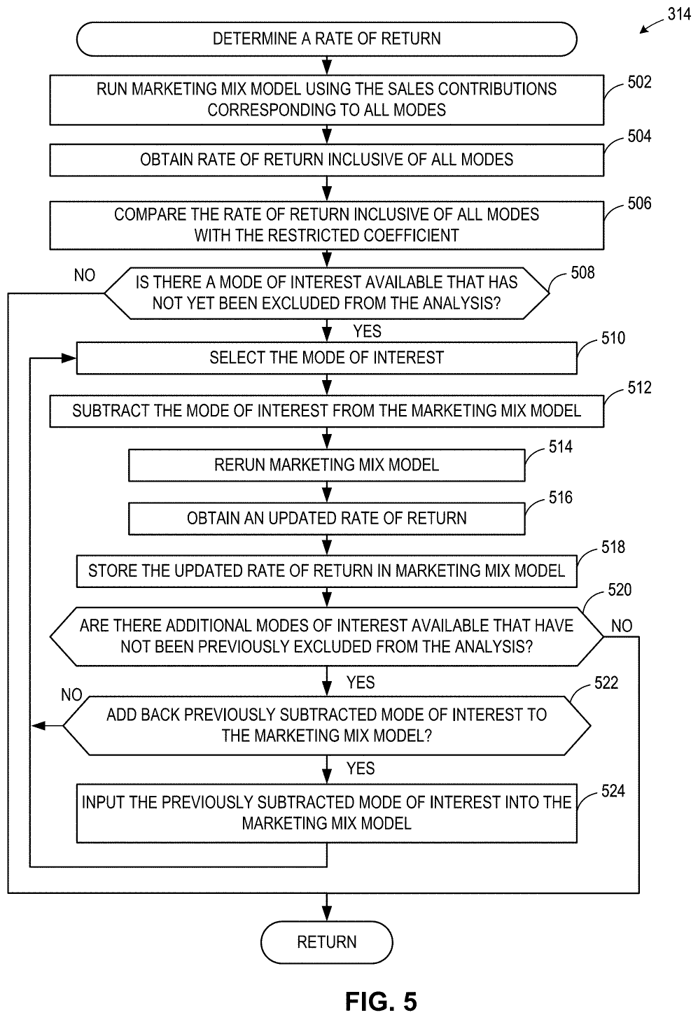

At block 316, the example contribution generator circuitry 208 determines the sales contributions based on the restricted coefficient. The sales contribution for all modes will be utilized by the example mode extraction circuitry 210 to determine rate of return data, as explained in further detail below in FIG. 5 (block 316).

At block 318, the example mode extraction circuitry 210 determines a rate of return, which is described in further detail below in FIG. 5.

FIG. 4 is a flowchart representative of additional detail corresponding to retrieving marketing activity data of block 302. In the illustrated example of FIG. 4, the example data retrieval circuitry 202 parses the marketing activity data to identify one or more modes (block 402). Examples disclosed herein include modes related to marketing activity campaigns, such as (but not limited to) television, radio, newspaper, etc. However, while examples disclosed herein use marketing activities to illustrate the inventive subject matter, such use cases are for illustration and not limitation. As described above, marketing activity data corresponds to each mode. As explained above, the use case disclosed herein can apply to marketing environment(s), but also examples disclosed herein can apply to any environment.

At block 404, the example data retrieval circuitry 202 determines if there is a mode available. The example data retrieval circuitry 202 proceeds to block 406 if the example data retrieval circuitry 202 determines there is a mode available (block 404). If not, the process returns to FIG. 3 (block 404).

At block 406, the example data retrieval circuitry 202 labels and stores the marketing activity data corresponding to the mode for later evaluation.

At block 408, the example data retrieval circuitry 202 determines if there are additional modes available. For example, during a prior iteration a first mode may have been discovered and/or otherwise identified, but one or more subsequent parsing iterations may reveal one or more additional/alternate modes of interest to be analyzed. The example data retrieval circuitry 202 proceeds to block 406 if the example data retrieval circuitry 202 determines there are additional modes available (block 408). If not, the process returns to block 304 of FIG. 3.

FIG. 5 is a flowchart representative of additional detail corresponding to determining a rate of return (block 314 of FIG. 3). In the illustrated example of FIG. 5, the example mode extraction circuitry 210 runs and/or otherwise executes the marketing mix model on the sales contributions correspond to all modes. As described above, all modes represent every mode that may be included in a particular campaign. For example, a first campaign may include three types of advertising vehicles to promote a particular product, such as an Internet advertising vehicle, a flyer/leaflet advertising vehicle, and a radio advertising vehicle. However, other campaigns may include a different quantity and/or type of mode mix.

At block 504, the example mode extraction circuitry 210 obtains the rate of return inclusive of all modes. For instance, and as described above, traditional modeling techniques in which two or more independent variables affect an output and/or otherwise cause a result are analyzed on a piecemeal basis in which a single independent variable is analyzed in isolation from one or more other independent variables. After such traditional techniques analyze a first independent variable, a separate modeling effort is invoked to analyze a corresponding effect of a second independent variable (e.g., a second mode type). When results corresponding to the two or more independent variables are derived using traditional techniques, computationally intensive post-modeling techniques are applied to attempt combining results of each independent variable. Aside from the computationally expensive tasks to attempt to combine results from separate modeling efforts, such approaches fail to consider potential co-dependency effects that may occur when two or more independent variables are present during data analysis. In other words, the effects of some independent variables on other independent variables are ignored and/or otherwise unknown when traditional siloed techniques are applied.

In contrast to the traditional modeling techniques described above, examples disclosed herein invoke the example mode extraction circuitry 210 to perform a modeling analysis in connection with all independent variables of interest (block 502) to obtain an overall modeling effect. As such, in the event one or more independent variables have some degree of effect on each other, the overall modeling results can include such phenomena.

At block 506, the example mode extraction circuitry 210 compares the rate of return inclusive of all modes with the restricted coefficient determined by the example coefficient determination circuitry 206.

At block 508, the example mode extraction circuitry 210 determines if there is a mode of interest that has not yet been analyzed based on its absence from the overall model analysis. In other words, an initial iteration through the example program 314 of FIG. 5 will always respond “YES” to such a question because models disclosed herein include two or more independent variables. The example mode extraction circuitry 210 proceeds to block 510 if the example mode extraction circuitry 210 determines there is a mode of interest to be excluded from an analysis (block 508). If not, meaning that prior iterations of the example program 314 of FIG. 5 have already occurred, then the process returns to FIG. 3 (block 508).

At block 510, the example mode extraction circuitry 210 selects the mode of interest to be excluded in a current model analysis iteration (e.g., one of the independent variables that was previously excluded in the model execution when all other independent variables were included) (block 508).

At block 512, the example mode extraction circuitry 210 subtracts the mode of interest from the marketing mix model. As such, when the newly formed model is evaluated without that particular mode, a revised model output can be determined that identifies what the contributory effect may have been for the missing/excluded mode.

At block 514, the example mode extraction circuitry 210 re-runs or re-applies the mixed marketing model based on the combination of remaining modes (e.g., the remaining independent variables in view of the recently removed independent variable).

At block 516, the example mode extraction circuitry 210 obtains an updated rate of return representing all modes minus the mode of interest.

At block 518, the example mode extraction circuitry 210 stores the updated rate of return.

At block 520, the example mode extraction circuitry 210 determines if there are additional modes of interest that have not been previously excluded. The example mode extraction circuitry 210 proceeds to block 522 if the example mode extraction circuitry 210 determines there are additional modes of interest that have not been previously excluded (block 520). If not, the process returns to FIG. 3 (block 520).

At block 522, the example mode extraction circuitry 210 determines if the previously extracted mode of interest is to be added back into the mixed marketing model. Stated differently, examples disclosed herein allow for different combinations of modes to be individually excluded or excluded as groups of two or more modes. For instance, if newspaper advertising was selected previously (e.g., excluded from the group of modes during a model evaluation) and a market participant would like to only obtain a rate of return for television advertising (a mode of interest that had not been previously excluded from analysis), then the example mode extraction circuitry 210 determines that the previously extracted mode of interest (newspaper advertising) is to be added back into the mixed marketing model (block 522). In other words, the example mode extraction circuitry 210 proceeds to block 524 if the example mode extraction circuitry 210 determines the previously extracted mode of interest is to be added back into the mixed marketing model (block 522). If not, the process proceeds to block 510 to obtain an updated rate of return for all modes minus the next mode of interest and previously extracted modes of interest (block 522). Using the above example, if the example mode extraction circuitry 210 determines not to add back the previously extracted of newspaper advertising, then the process proceeds to block 510 where the television advertising and newspaper advertising will be taken into account when subsequently obtaining a rate of return (block 522).

At block 524, the example mode extraction circuitry 210 inputs, into the mixed marketing model, the previously extracted mode of interest if the example mode extraction circuitry 210 determines to add back, into the mixed marketing model, the previously extracted mode of interest (block 524). If the example mode extraction circuitry 210 determines the previously extracted mode of interest is to be added back into the mixed marketing model (block 522), then the previously subtracted mode if interest is inputted back into the marketing mix model (block 524). Block 524 proceeds to block 510 after the previously subtracted mode of interest is added back into the marketing mix model (block 524).

FIG. 6 is a block diagram of an example processor platform 600 structured to execute and/or instantiate the machine readable instructions and/or the operations of FIGS. 3-5 to implement the example rate of return circuitry 102 of FIG. 2A. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs, microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the example data retrieval circuitry 202, example data transformer circuitry 204, example coefficient determination circuitry 206, example contribution generator circuitry 208, example mode extraction circuitry 210, and example rate of return circuitry 102 as illustrated in FIG. 2A.

The processor circuitry 612 of the illustrated example includes a local memory 613 (e.g., a cache, registers, etc.). The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 632, which may be implemented by the machine readable instructions of FIGS. 3-5, may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a microprocessor 700. For example, the microprocessor 700 may be a general purpose microprocessor (e.g., general purpose microprocessor circuitry). The microprocessor 700 executes some or all of the machine readable instructions of the flowcharts of FIGS. 3-5 to effectively instantiate the circuitry of FIG. 2A as logic circuits to perform the operations corresponding to those machine readable instructions. In some such examples, the circuitry of FIG. 2A is instantiated by the hardware circuits of the microprocessor 700 in combination with the instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 3-5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may be implemented by at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 8 is a block diagram of another example implementation of the processor circuitry 612 of FIG. 6. In this example, the processor circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowcharts of FIGS. 3-5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowcharts of FIGS. 3-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowcharts of FIGS. 3-5. As such, the FPGA circuitry 800 may be structured to effectively instantiate some or all of the machine readable instructions of the flowcharts of FIGS. 3-5 as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 3-5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may be implemented by external hardware circuitry. For example, the external hardware 806 may be implemented by the microprocessor 700 of FIG. 7. The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations that may correspond to at least some of the machine readable instructions of FIGS. 3-5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowcharts of FIGS. 3-5 may be executed by one or more of the cores 702 of FIG. 7, a second portion of the machine readable instructions represented by the flowcharts of FIGS. 3-5 may be executed by the FPGA circuitry 800 of FIG. 8, and/or a third portion of the machine readable instructions represented by the flowcharts of FIGS. 3-5 may be executed by an ASIC. It should be understood that some or all of the circuitry of FIG. 2A may, thus, be instantiated at the same or different times. Some or all of the circuitry may be instantiated, for example, in one or more threads executing concurrently and/or in series. Moreover, in some examples, some or all of the circuitry of FIG. 2A may be implemented within one or more virtual machines and/or containers executing on the microprocessor.

In some examples, the processor circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 3-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 3-5, may be downloaded to the example processor platform 600, which is to execute the machine readable instructions 632 to implement the example rate of return circuitry 102. In some examples, one or more servers of the software distribution platform 905 periodically offer, transmit, and/or force updates to the software (e.g., the example machine readable instructions 632 of FIG. 600) to ensure improvements, patches, updates, etc., are distributed and applied to the software at the end user devices.

From the foregoing, it will be appreciated that example systems, methods, apparatus, and articles of manufacture have been disclosed that improve modeling efficiency. Disclosed systems, methods, apparatus, and articles of manufacture improve the efficiency of using a computing device by streamlining the modeling process to estimate all modes of interest in a codependent manner. In other words, examples disclosed herein appreciate circumstances in which some modes of interest have some effect on other modes of interest. Thus, when such different modes are evaluated independently of each other, particular effects cannot be appreciated and/or otherwise detected. Additionally, when traditional siloed techniques are applied, computationally expensive post-processing tasks are necessary to combine the independently analyzed modes. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to improve modeling efficiency are disclosed herein. Further examples and combinations thereof include the following:

Example 1 includes an apparatus to improve modeling efficiency comprising memory, machine readable instructions, and processor circuitry to at least one of instantiate or execute the machine readable instructions to identify a first quantity of modes corresponding to a task, apply a model to the first quantity of modes to determine a first contributory effect corresponding to the task, select a first portion of the first quantity of modes to exclude to generate a second quantity of modes corresponding to the task, apply the model to the second quantity of modes to determine a second contributory effect corresponding to the task, and cause a trigger response based on a difference value between the first contributory effect and the second contributory effect.

Example 2 includes the apparatus as defined in example 1, wherein the first quantity of modes corresponding to the task corresponds to marketing activity data.

Example 3 includes the apparatus as defined in example 2, wherein the task includes a rate of return on the marketing activity data that includes the first quantity of modes.

Example 4 includes the apparatus as defined in example 1, wherein the first contributory effect and the second contributory effect correspond to performance metrics corresponding to the task.

Example 5 includes the apparatus as defined in example 1, wherein the first quantity of modes corresponding to the task is transformed by a decay rate.

Example 6 includes the apparatus as defined in example 5, wherein the first quantity of modes corresponding to the task transformed by the decay rate is further transformed by a saturation factor.

Example 7 includes the apparatus as defined in example 6, wherein the first quantity of modes corresponding to the task transformed by the decay rate and saturation factor is used to determine a coefficient.

Example 8 includes the apparatus as defined in example 7, wherein the coefficient is restricted by applying a truncated normal distribution model to generate a restricted coefficient.

Example 9 includes the apparatus as defined in example 8, wherein the restricted coefficient is compared with the first contributory effect corresponding to the task.

Example 10 includes a non-transitory machine readable storage medium comprising instructions that, when executed, cause processor circuitry to at least identify a first quantity of modes corresponding to a task, apply a model to the first quantity of modes to determine a first contributory effect corresponding to the task, select a first portion of the first quantity of modes to exclude to generate a second quantity of modes corresponding to the task, apply the model to the second quantity of modes to determine a second contributory effect corresponding to the task, and cause a trigger response based on a difference value between the first contributory effect and the second contributory effect.

Example 11 includes the non-transitory machine readable storage medium as defined in example 10, wherein the first quantity of modes corresponding to the task corresponds to marketing activity data.

Example 12 includes the non-transitory machine readable storage medium as defined in example 11, wherein the task includes a rate of return on the marketing activity data that includes the first quantity of modes.

Example 13 includes the non-transitory machine readable storage medium as defined in example 10, wherein the first contributory effect and the second contributory effect correspond to performance metrics corresponding to the task.

Example 14 includes the non-transitory machine readable storage medium as defined in example 10, wherein the first quantity of modes corresponding to the task is transformed by a decay rate.

Example 15 includes the non-transitory machine readable storage medium as defined in example 14, wherein the first quantity of modes corresponding to the task transformed by the decay rate is further transformed by a saturation factor.

Example 16 includes the non-transitory machine readable storage medium as defined in example 15, wherein the first quantity of modes corresponding to the task transformed by the decay rate and saturation factor is used to determine a coefficient.

Example 17 includes the non-transitory machine readable storage medium as defined in example 16, wherein the coefficient is restricted by applying a truncated normal distribution model to generate a restricted coefficient.

Example 18 includes the non-transitory machine readable storage medium as defined in example 17, wherein the restricted coefficient is compared with the first contributory effect corresponding to the task.

Example 19 includes a method to improve modeling efficiency comprising identifying a first quantity of modes corresponding to a task, applying a model to the first quantity of modes to determine a first contributory effect corresponding to the task, selecting a first portion of the first quantity of modes to exclude to generate a second quantity of modes corresponding to the task, applying the model to the second quantity of modes to determine a second contributory effect corresponding to the task, and causing a trigger response based on a difference value between the first contributory effect and the second contributory effect.

Example 20 includes the method as defined in example 19, wherein the first quantity of modes corresponding to the task corresponds to marketing activity data.

Example 21 includes the method as defined in example 20, wherein the task includes a rate of return on the marketing activity data that includes the first quantity of modes.

Example 22 includes the method as defined in example 19, wherein the first contributory effect and the second contributory effect correspond to performance metrics corresponding to the task.

Example 23 includes the method as defined in example 19, wherein the first quantity of modes corresponding to the task is transformed by a decay rate.

Example 24 includes the method as defined in example 23, wherein the first quantity of modes corresponding to the task transformed by the decay rate is further transformed by a saturation factor.

Example 25 includes the method as defined in example 24, wherein the first quantity of modes corresponding to the task transformed by the decay rate and saturation factor is used to determine a coefficient.

Example 26 includes the method as defined in example 25, wherein the coefficient is restricted by applying a truncated normal distribution model to generate a restricted coefficient.

Example 27 includes the method as defined in example 26, wherein the restricted coefficient is compared with the first contributory effect corresponding to the task.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to improve modeling efficiency comprising:
memory;
machine readable instructions; and
processor circuitry to at least one of instantiate or execute the machine readable instructions to:
identify a first quantity of modes corresponding to a task;
apply a model to the first quantity of modes to determine a first contributory effect corresponding to the task;
select a first portion of the first quantity of modes to exclude to generate a second quantity of modes corresponding to the task;
apply the model to the second quantity of modes to determine a second contributory effect corresponding to the task; and
cause a trigger response based on a difference value between the first contributory effect and the second contributory effect.

2. The apparatus as defined in claim 1, wherein the first quantity of modes corresponding to the task corresponds to marketing activity data.

3. The apparatus as defined in claim 2, wherein the task includes a rate of return on the marketing activity data that includes the first quantity of modes.

4. The apparatus as defined in claim 1, wherein the first contributory effect and the second contributory effect correspond to performance metrics corresponding to the task.

5. The apparatus as defined in claim 1, wherein the first quantity of modes corresponding to the task is transformed by a decay rate.

6. The apparatus as defined in claim 5, wherein the first quantity of modes corresponding to the task transformed by the decay rate is further transformed by a saturation factor.

7. The apparatus as defined in claim 6, wherein the first quantity of modes corresponding to the task transformed by the decay rate and saturation factor is used to determine a coefficient.

8. The apparatus as defined in claim 7, wherein the coefficient is restricted by applying a truncated normal distribution model to generate a restricted coefficient.

9. The apparatus as defined in claim 8, wherein the restricted coefficient is compared with the first contributory effect corresponding to the task.

10. A non-transitory machine readable storage medium comprising instructions that, when executed, cause processor circuitry to at least:
identify a first quantity of modes corresponding to a task;
apply a model to the first quantity of modes to determine a first contributory effect corresponding to the task;
select a first portion of the first quantity of modes to exclude to generate a second quantity of modes corresponding to the task;
apply the model to the second quantity of modes to determine a second contributory effect corresponding to the task; and
cause a trigger response based on a difference value between the first contributory effect and the second contributory effect.

11. The non-transitory machine readable storage medium as defined in claim 10, wherein the first quantity of modes corresponding to the task corresponds to marketing activity data.

12. The non-transitory machine readable storage medium as defined in claim 11, wherein the task includes a rate of return on the marketing activity data that includes the first quantity of modes.

13. The non-transitory machine readable storage medium as defined in claim 10, wherein the first contributory effect and the second contributory effect correspond to performance metrics corresponding to the task.

14. The non-transitory machine readable storage medium as defined in claim 10, wherein the first quantity of modes corresponding to the task is transformed by a decay rate.

15. The non-transitory machine readable storage medium as defined in claim 14, wherein the first quantity of modes corresponding to the task transformed by the decay rate is further transformed by a saturation factor.

16. The non-transitory machine readable storage medium as defined in claim 15, wherein the first quantity of modes corresponding to the task transformed by the decay rate and saturation factor is used to determine a coefficient.

17. The non-transitory machine readable storage medium as defined in claim 16, wherein the coefficient is restricted by applying a truncated normal distribution model to generate a restricted coefficient.

18. The non-transitory machine readable storage medium as defined in claim 17, wherein the restricted coefficient is compared with the first contributory effect corresponding to the task.

19. A method to improve modeling efficiency comprising:
identifying a first quantity of modes corresponding to a task;
applying a model to the first quantity of modes to determine a first contributory effect corresponding to the task;
selecting a first portion of the first quantity of modes to exclude to generate a second quantity of modes corresponding to the task;
applying the model to the second quantity of modes to determine a second contributory effect corresponding to the task; and
causing a trigger response based on a difference value between the first contributory effect and the second contributory effect.

20. The method as defined in claim 19, wherein the first quantity of modes corresponding to the task corresponds to marketing activity data.

21-27. (canceled)
